(19) United States
(12) Patent Application Publication
(10) Pub. No.: US 2009/0064879 A1
(43) Pub. Date: Mar. 12, 2009

(54) METHOD FOR OPERATING A SHAFTLESS PRINTING PRESS AND SHAFTLESS PRINTING PRESS

(76) Inventors: Stephan Schultze, Lohr (DE); Christoph Mueller, Lohr (DE)

Correspondence Address: MICHAEL J. STRIKER, 103 EAST NECK ROAD, HUNTINGTON, NY, 11743, US

(21) Appl. No.: 12/173,155

(22) Filed: Jul. 15, 2008

(30) Foreign Application Priority Data
Jul. 26, 2007 (DE) 10 2007 034 835.7

(51) Int. Cl. B41F 31/00

(52) U.S. Cl. 101/141

(57) ABSTRACT

The present invention relates to a method for operating a shaftless printing press (1), in which a product (5) is processed during a processing operation by at least one processing device (4a, 4b, 4c), wherein the processing device has at least one driven processing axle (6) as well as at least one further driven axle (11); a processing length (13) of the product (5) is capable of being predetermined by means of the rotary speed (1a, 1b) of the at least one processing axle (6); and the rotary speed (1a, 1b) of the at least one further driven axle (11) is predetermined as a function of the set-point rotary speed (1a, 1b) of the at least one processing axle (6). The present invention further relates to a corresponding printing press, a corresponding computer program, and a corresponding computer program product.

The invention relates to a method for operating a shaftless printing press, to a shaftless printing press, to a corresponding computer program, and to a corresponding computer program product.

In the printing field, flexible printing tools are now widely used. They are fastened to impression cylinders, and the fastening of the printing tools to the impression cylinders can cause expansion of the printing tools. The result is a variable tool length, which disadvantageously results in a variable printing length. This is the case for instance with flexographic printing blocks, which are designed as flexible and expandable in rubberlike fashion, so that unknown printing lengths are not caused by the fastening of the flexographic printing blocks to the impression cylinders.

Moreover, regardless of the printing block height, the fastening length is the same for all the printing blocks, so that because of the different printing block heights, different rolling lengths for the individual printing blocks can result. The same situation obtains if processing tools used are not manufactured with sufficient precision or are subject to production variations. A study of this effect is described for instance in the article entitled “Drucklängenausgleich beim Wellpappendirektdruck” [“Printing Length Compensation in Direct Printing onto Cardboard”] in the April 2001 issue of Flexoprint.

In individual imprinting materials, an input of moisture or a drying operation after a processing step can lead to a change in the size of the imprinting material between individual processing operations.

As a result of the described variable printing length and sizes of the imprinting materials, in the course of a printing operation, variable printing lengths for the individual processing tools can disadvantageously occur as well. As a result, the printing operations for the individual processing tools are not in register, and the overall imprint is not clean in appearance.

It is already known that the variable tool lengths described can be manually corrected. To that end, the effective printing lengths of the individual processing tools on the printed sheets are measured individually. From these printing lengths for the individual processing tools, correction values are ascertained that are input manually into a printing system. This disadvantageously results in complicated, inconvenient handling, which because it is time-consuming undesirably prolongs the processing operation. For a plurality of impression cylinders whose printing lengths are corrected manually, the result can be a disadvantageous high additional processing effort and expense.

### PRIOR ART

In German Patent Disclosure DE 10 2005 007 435 A1, a method for performing a printing correction is disclosed, in which automatic correction of printing length and printing position correction is possible. In this method, it is found to be disadvantageous that in a printing length correction of a processing axle, axles belonging to the processing axle are adversely affected, resulting for instance in an uneven application of ink to a print roller from an associated matrix roller.

### Stated Object

It is the object of the present invention to overcome the disadvantages of the prior art.

The invention is attained by means of a method for operating a shaftless printing press, and by a shaftless printing press, a corresponding computer program, and a corresponding computer program product, having the characteristics of the independent claims. Preferred features of the invention are the subject of the dependent claims.

In the method according to the invention for operating a shaftless printing press, a product is processed during a processing operation by at least one processing device. The printing press may in particular be a flexographic printing press, an offset printing press, a sheet-fed printing press, a metal-imprinting press, or a cardboard printing press. The processing device has at least one driven processing axle and at least one further driven axle. The latter is operatively connected in particular to the processing axle in a manner coupled by friction- and/or force-locking or is intended to move synchronously to the driven axle. Such axles typically roll on one another. An electronic coupling may be involved as well. In the case of a flexographic printing unit, the driven processing axle is in particular the print roller, and the further driven axle is the matrix roller operatively connected to it.

A processing length of the product, that is, the length of a region of the product, that is, the length in the direction of motion of a region of the product that is processed during the processing operation by the at least one processing axle can be predetermined by means of the rotary speed of the processing axle. Typically, this is a printing length, but it can also be a stamping spacing or the like. Typically, the processing length is inverse to the rotary speed of the processing axle. If the processing axle is rotating faster, the processing length becomes shorter, and vice versa. The processing is typically a frictional rolling motion on the material that is moved relative to the processing axle.

The rotary speed of the at least one further driven axle is predetermined as a function of the set-point rotary speed of the at least one processing axle and in particular synchronously to it. The predetermination of the rotary speed can be done dynamically as a function of time, which includes predetermining a positive or negative rotational acceleration.

A printing press according to the invention has means for performing a method according to the invention.

### ADVANTAGES OF THE INVENTION

By means of the provision according to the invention, greater rigidity and sturdiness of the further driven axles can be parametrized, given the associated axle regulating parameters, since smoother set-point values are achieved. The adverse effects of asynchronously rotating cooperating rollers, such as greater wear of the printing block or the occurrence of striation in the printed image, can be avoided. A rotational course that is as synchronous as possible can be achieved by orienting the set-point rotary speed of the further driven, associated or coupled, axle to the set-point rotary speed of the processing axle. A predetermined rotary speed is typically a set-point rotary speed.

Advantageously, the rotary speed of the at least one further driven axle is predetermined by means of a (real or virtual) guide axle or axis on the basis of the set-point rotary speed of the at least one processing axle. By the predetermining of at least one real guide axle or axis on the basis of the set-point rotary speed of the at least one processing axle, an idle time in the calculation of the real guide axle or axis and hence the imprecision of the coupled axle to the processing axle can be reduced.

In a preferred feature, the processing length of the product is predetermined by means of a cam disk function acting on the rotary speed of the at least one processing axle, and the rotary speed of the at least one further driven axle is predetermined by means of the same cam disk function. This term should be understood to mean that identical cam disk relationships are employed, such as identical cam disk tables. The cam disk function of the further axle is selected such that no relative motion between the axles occurs.

It is expedient if the cam disk function acting on the set-point rotary speed of the at least one processing axle is generated in a decentralized control unit in the processing device and is forwarded to the drive of the at least one processing axle and to the drive of the at least one further axle.

Advantageously, the cam disk function acting on the set-point rotary speed of the at least one processing axle is generated in a central control unit of the printing press and is forwarded to the drive of the at least one processing axle and to the drive of the at least one further axle. If the cam disk function is advantageously calculated at a central point, for instance inside a central controller instead of in decentralized fashion in the drives, then the output of the cam disk function can be distributed over a plurality of axles. Downstream of the cam disk function in terms of the signal flow direction, a so-called partial guide axle forms, which in contrast to the virtual guide axis of the machine motion no longer executes a constant motion but rather executes a motion that contains the printing length correction. This dimension is then transmitted not only to the processing axle but also to the associated further axle.

In a further preferred feature, the at least one driven processing axle is embodied as a printing ink-transferring axle, in particular as an impression cylinder or a rubber blanket cylinder, and/or the at least one further driven axle is embodied as an impression cylinder (offset printing), matrix roller (flexographic printing), ink ductor roller, distributing roller, ink applicator roller, ink transport roller, or moistening roller. The method of the invention can be used especially advantageously in such shaftless printing presses, since in that case, predetermined couplings exist between the processing axles and the associated further driven axles.

The invention furthermore relates to a computer program with program code means, for performing all the steps of a method according to the invention, if the computer program is executed on a computer or a corresponding computation unit, in particular in a processing or printing press according to the invention.

The computer program product, provided according to the invention, having program code means that are stored in memory on a computer-readable data medium, for performing all the steps of a method, if the computer program is executed on a computer or a corresponding computation unit, in particular in a processing or printing press. Suitable data media are in particular diskettes, hard drives, flash drives, EEPROMs, CD-ROMs, DVDs, and more. Downloading a program via computer networks (Internet, Intranet, etc.) is also possible.

Further advantages and features of the invention will become apparent from the description and the accompanying drawings.

It is understood that the characteristics given above and those to be described further below can be used not only in the particular combination indicated but in still other combinations or alone, without departing from the scope of the present invention.

The invention is shown schematically in the drawings in terms of an exemplary embodiment and will be described in detail below in conjunction with the drawings.

### DESCRIPTION OF THE DRAWINGS

FIG. 1 shows a schematic view of a printing correction (cam disk function);

FIG. 2 shows a print area of a printed product in which a first and a second processing device have each made two printed marks, the application of the printed marks having been done without any printing correction;

FIG. 3 shows a printed product in accordance with FIG. 3, in which a printing correction has been made; and

FIG. 4 is a schematic illustration of a preferred embodiment of a printing press.

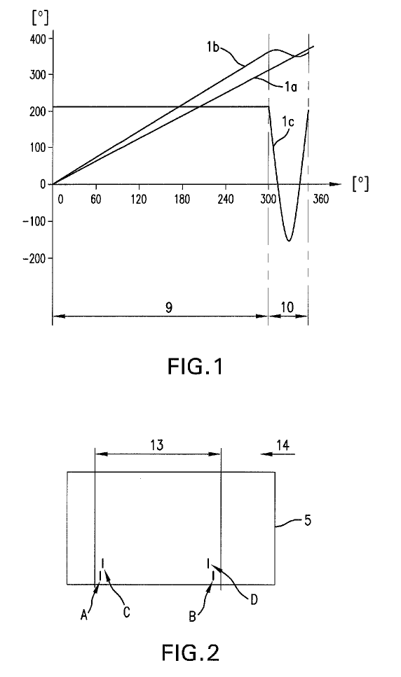

FIG. 1, in a graph, shows a basic illustration of a printing correction. In the graph, a machine angle (such as a working angle of a transporting roller or a counterimpression cylinder) of a printing system is plotted on the X axis. On the Y axis, an angle of an impression cylinder of the printing system is plotted. A first range 9 on the X axis defines a printing range, and a second range 10 on the X axis defines a print-free zone of the printing system, that is, a region of the printing system in which no printing of the product to be printed is performed. An essentially linear course 1a represents an uncorrected course of the machine angle over the angle of the impression cylinder. In this range, the two angles extend synchronously to one another, so that as a result, identical speeds of a printing product and of an impression cylinder with a printing block fastened onto it are achieved. This can be seen in the graph from the fact that the counterimpression cylinder has together with the impression cylinder performed one complete revolution (360°).

A course 1b represents a printing length-corrected course of the machine angle over the angle of the impression cylinder. The course 1b is steeper than the course 1a; the impression cylinder thus reaches one complete revolution earlier than the counterimpression cylinder does. In FIG. 1, it is shown that the impression cylinder has performed one complete revolution (from 0° to 360°) approximately at a time at which the counterimpression has just rotated from 0° to 300°. This means that the impression cylinder with the flexographic printing block fastened to it is rotating at a higher angular speed than an axle of the printing system that drives the counterimpression cylinder. As a consequence of these different angular speeds, a relative motion develops between the impression cylinder, with the flexographic printing block fastened to it, and the printing product. Although the result is increased wear of the printing block from friction, on the other hand, the print area (first range 9) of the printing product is advantageously completely filled by the printing length of the flexographic printing block.

In the second range 10 in FIG. 1, a course 1c illustrates a speed course of a correction motion of the impression cylinder. In this range, the impression cylinder is positionally corrected with the printing block in such a way that at the beginning of the next print area, at 360° or 0°, it resumes a defined common position jointly with the counterimpression cylinder. In FIG. 1, it is shown that the impression cylinder, in the print-free zone, is executing a braking motion (negative slope of the S curve). As a consequence, the speed course of the correction motion of the impression cylinder briefly enters the negative range; that is, the impression cylinder and the counterimpression cylinder briefly have contrary angular speeds. Typically, the speed course remains entirely within the positive range, however, which means that the angular speed of the impression cylinder has the same sign as the angular speed of the counterimpression cylinder.

The correction shown in principle in FIG. 1 of an error in a printing length is also known in the prior art as an APM function (anti-print-enlargement mode).

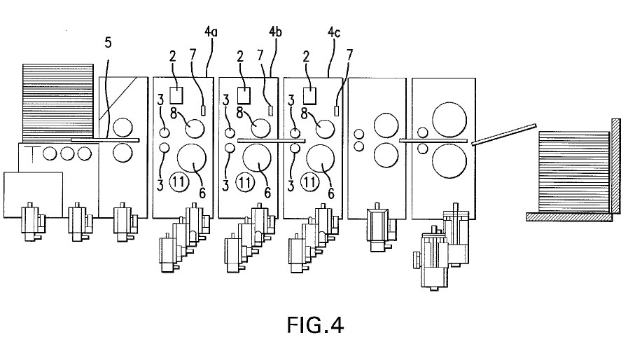

In a preferred embodiment of the invention, the printing length correction function (cam disk function) 1b shown is also used for predetermining the set-point rotation of a further driven axle or an axle belonging to the printing axle. In the prior art, the further driven axles, which in the example described are a matrix roller for applying ink to the print roller, are typically not adapted to the rotation of the print roller, or they are regulated to the actual rotation of the printing axle. Both options lead to a lessening of the print precision. By the predetermination of the rotation in accordance with the printing length correction function 1b to the associated matrix roller, synchronous rotation of the two coupled rollers can be attained. A corresponding printing press will be described hereinafter in conjunction with FIG. 4.

FIG. 2 shows a print area of a printing product 5. In the print area, a first printed mark A and a second printed mark B have been applied by a first processing device. Also in the print area, a first printed mark C and a second printed mark D have been applied by a second processing device. Together with the printed marks A, B, C, D, printed images of the processing devices can also have been applied. For the sake of simplicity, these imprints are not shown in FIG. 2. It can be seen that the first printed marks in each case, A and C, of the two processing devices have different spacings in relation to a front edge, in terms of the material flow direction 14, of the printing product 5. It can also be seen from FIG. 2 that the second printed marks B, D in each case have different spacings in relation to a rear edge, in terms of the material flow direction 14 of the printing product 5. The two printed marks A, B of the first processing device have lesser spacings from the edges of the printing product 5 than the two printed marks C, D of the second processing device. As a consequence, the printing length 13 of the first processing device is greater than the printing length of the second processing device. It can also be seen that in the material flow direction, the two first marks A, C of the first and second processing device, respectively, are located in the region of a front edge of the print area, and the two second marks B, D of the two processing devices are located in a rear region of the print area. FIG. 2 shows a state of the printing product 5 before a printing correction is performed.

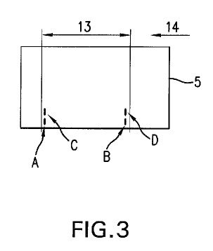

FIG. 3 shows the printing product 5 after a correction of the printing length has been made. It can be seen that the first printed marks A, C of the first and second processing devices, respectively, have essentially identical spacings relative to the respective second printed marks B, D of the two processing devices. This means that the printing lengths 13 of the two processing devices have been corrected, or in other words that the printing length 13 of the second processing device has been adapted to the printing length 13 of the first processing device.

Advantageously, different printing lengths of the two processing devices are thus essentially compensated for. In the printing correction, in the print area 9 (FIG. 1), a relative motion takes place between the impression cylinder and the counterimpression cylinder as a consequence of different tool lengths. As a result, the different printing lengths of the individual impression cylinders can be compensated for.

It can also be seen in FIG. 3 that a correction of the print position can be performed. This means that the two first printed marks A, C are located essentially identically relative to the front edge of the printing product 5. More precisely, it can be seen that the two first printed marks A, C of the two processing devices are oriented in such a way that they have essentially identical spacings from the front edge of the print area of the printed product 5. This corresponds to a positional regulation for the two first printed marks A, C by means of a printing system in the print-free zone 10 (FIG. 1).

The positions of the corrected printed marks C, D in FIG. 3 should be considered merely as examples, so that arbitrarily predeterminable positions of these first and second printed marks C, D of the second processing device are also conceivable. Essentially, a fixed, predeterminable position of the printed marks of the first and the second processing devices to one another is the result of the printing correction. From FIG. 3, a regulating strategy can be seen that is designed such that printed marks A, B applied by the first processing device are used to regulate printing steps of subsequent processing devices.

FIG. 4 shows a preferred embodiment of a printing press 1 according to the invention, with which the method of the invention can be performed. The printing press 1 includes a plurality of processing devices, embodied as flexographic printing units 4a, 4b, 4c, in which a printing product 5 is imprinted by a respective driven processing axle embodied as an impression cylinder 6. A further driven axle embodied as a matrix roller 11 belongs to each impression cylinder 6. Between each impression cylinder 6 and the associated matrix roller 11 there is an operative connection, in the form of a friction- and/or force-locking coupling.

With the aid of transporting devices 3, the printing product 5 is transported from one flexographic printing unit 4a, 4b, 4c to the next. A device 2 serves to detect and evaluate the positions of the printed marks on the printed products 5. The device 2 can for instance have a photoelectric barrier, a camera, and a computation unit, which are used for delivering ascertained correction data to the flexographic printing units 4a, 4b, 4c. On the basis of the correction data, it is possible for the flexographic printing units 4a, 4b, 4c to apply the printed marks in a positionally variable way to the printed products 5. Regulator outputs 7 of the flexographic printing units 4a, 4b, 4c detect an outcome of the printing correction; that is, they ascertain whether the result of the printing correction has been a shortening or lengthening of the printing length.

As actuators of the printing length correction, both the flexographic printing units 4a, 4b, 4c and the transporting device 3 can be used. In the first case, the transporting of the printing product 5 is effected with the aid of the transporting device 3 at a largely constant speed, and the impression cylinders 6 of the flexographic printing units 4a, 4b, 4c execute a relative motion to the printed product 5. In the second case, the transporting of the printed product 5 is effected with the aid of the transporting device 3 at a nonconstant speed. As a consequence, the operation of transporting the printed product 5 is corrected, which can be performed for instance by means of correcting a speed controller for the transporting device 3. This second case, however, is not relevant to the preferred predetermination of the rotary speed to the matrix rollers 11 and is mentioned here only for the sake of completeness.

The course of the method of the invention in the printing press 1 will now be described in principle. The product 5 to be printed is delivered to the first flexographic printing unit 4a by means of the transporting device 3. In the first flexographic printing unit 4a, the first printed mark A and the second printed mark B are applied. In the further course, the printed product 5 is delivered by means of the transporting device 3 to the second flexographic printing unit 4b. There, the first printed mark C and the second printed mark D of the second flexographic printing unit 4b are applied to the printed product 5. After that, the printed product 5, with the printed marks A, B, C, D applied to it, is delivered by the transporting device 3 to the third flexographic printing unit 4c. The device 2 for detecting positions and printed marks of the third flexographic printing unit 4c detects the positions of the printed marks A, B, C, D on the printed product 5 and evaluates the positions of the printed marks A, B, C, D. If the device 2 ascertains that the spacing of the printed marks A and B differs from the spacing of the printed marks C and D, this means that the effective printing lengths of the first flexographic printing unit 4a and of the second flexographic printing unit 4b are different.

As a corrective provision, the second flexographic printing unit 4b is thereupon triggered, via a regulator output 7 of the third flexographic printing unit 4c. As a result, in the next product 5 to be printed that is delivered to the second flexographic printing unit 4b, the impression cylinder 6 is triggered by means of a cam disk function and is moved in relation to the printing product 5 in such a way that the second flexographic printing unit 4b, in comparison to the first flexographic printing unit 4a, generates a substantially identical printing length on the printed product 5. In the preferred embodiment described, the set-point rotation of the matrix roller 11 of the second flexographic printing unit 4b is predetermined on the basis of the correction values for the impression cylinder 6 of the second flexographic printing unit 4b. In the embodiment shown, the aforementioned cam disk function is forwarded both to the drive of the printing unit 6 and to the drive of the matrix roller 11 of the second flexographic printing unit 4b, in order to attain synchronous rotation of the rollers. The rotation of the two axles is accordingly regulated such that no relative rotation occurs. A parameter value for the correction motion of the second flexographic printing unit 4b can be stored in memory in the second flexographic printing unit 4b, so that for all the further products 5 to be printed, during their processing by the second flexographic printing unit 4b, the preferred coupling is automatically performed.

As a refinement of the method of the invention, via the regulator output 7 of the third flexographic printing unit 4c, the second flexographic printing unit 4b can be triggered in such a way that the positions of the first printed marks C are adapted to the position of the first printed mark A of the first flexographic printing unit 4a. As a result, in addition to the printing length correction, a printing position correction is favorably made, and according to the invention, the motion of the matrix roller corresponds to the motion of the impression cylinder.

It is understood that the correction method described is not limited to a correction of the printed marks C, D of only the second flexographic printing unit 4b, but instead can extend to many various processing devices 4a, 4b, 4c. However, only the correction of printed marks C, D of the second flexographic printing unit 4b has been described above, for simplicity.

The method according to the invention can advantageously be performed with various types of processing devices 4a, 4b, 4c, as long as they have a further driven axle that interacts with the processing axle. For instance, the driven processing axle 6 can be embodied as a printing ink-transferring axle, and in particular as an impression cylinder or rubber blanket cylinder. The at least one further driven axle 11 can be embodied as an impression cylinder, matrix rollers, ink ductor roller, distributing roller, ink applicator roller, ink transport roller, or moistening roller.

It is understood that in the drawings shown, only one particularly preferred embodiment of the invention is shown. In addition to it, any other embodiment is conceivable without departing from the scope of this invention.

### LIST OF REFERENCE NUMERALS

1a Linear printing course
1b Printing length-corrected printing course
1c Speed course
9 First range
10 Second range
5 Printed product, or product to be printed
13 Processing length
14 Material flow direction
A, B, C, D Printed mark
1 Printing press
2 Detection device
3 Transporting device
4a, 4b, 4c Flexographic printing unit
6 Impression cylinder
7 Regulator output
8 Counterimpression cylinder
11 Matrix roller

1. A method for operating a shaftless printing press (1), in which a product (5) is processed during a processing operation by at least one processing device (4a, 4b, 4c), wherein the processing device has at least one driven processing axle (6) as well as at least one further driven axle (11); a processing length (13) of the product (5) is capable of being predetermined by means of the rotary speed (1a, 1b) of the at least one processing axle (6); and the rotary speed (1a, 1b) of the at least one further driven axle (11) is predetermined as a function of the set-point rotary speed (1a, 1b) of the at least one processing axle (6).

2. The method as defined by claim 1, wherein the rotary speed (1a, 1b) of the at least one further driven axle (11) is predetermined by means of a guide axle or axis on the basis of the set-point rotary speed (1a, 1b) of the at least one processing axle (6).

3. The method as defined by claim 1, wherein the processing length (13) of the product (5) is predetermined by means of a cam disk function (1b) acting on the set-point rotary speed (1a, 1b) of the at least one processing axle (6); and the rotary speed (1a, 1b) of the at least one further driven axle (11) is predetermined by means of the same cam disk function (1b).

4. The method as defined by claim 3, wherein the cam disk function (1b) acting on the set-point rotary speed (1a, 1b) of the at least one processing axle (6) is generated in a decentralized control unit in the processing device (4a, 4b, 4c) and is forwarded to the drive of the at least one processing axle (6) and to the drive of the at least one further axle (11).

5. The method as defined by claim 3, wherein the cam disk function (1b) acting on the set-point rotary speed (1a, 1b) of the processing axle (6) is generated in a central control unit of the printing press (1) and is forwarded to the drive of the at least one processing axle (6) and to the drive of the at least one further axle (11).

6. The method as defined by claim 1, wherein the at least one driven processing axle (6) is embodied as a printing ink-transferring axle, in particular as a impression cylinder or a rubber blanket cylinder, and/or the at least one further driven axle (11) is embodied as an impression cylinder, matrix rollers, ink ductor roller, distributing roller, ink applicator roller, ink transport roller, or moistening roller.

7. A shaftless printing press, in which a product (5) is processed during a processing operation by at least one processing device (4a, 4b, 4c), wherein the processing device (4a, 4b, 4c) has at least one driven processing axle (6) as well as at least one further driven axle (11),
having first means, which are arranged for predetermining the rotary speed (1a, 1b) of the processing axle (6) and thus a processing length (13) of the product (5); and
having second means, which are arranged for predetermining the rotary speed (1a, 1b) of the at least one further driven axle (11) as a function of the set-point rotary speed (1a, 1b) of the at least one processing axle (6).

8. The shaftless printing press as defined by claim 7, wherein the first means and/or the second means is embodied in a decentralized control unit in the at least one processing device (4a, 4b, 4c).

9. The shaftless printing press as defined by claim 7, wherein the first means and/or the second means is embodied in a central control unit of the printing press (1).

10. The shaftless printing press as defined claim 7, in which the at least one driven processing axle (6) is embodied as a printing ink-transferring axle, in particular as an impression cylinder or a rubber blanket cylinder, and/or the at least one further driven axle (11) is embodied as an impression cylinder, matrix roller, ink ductor roller, distributing roller, ink applicator roller, ink transport roller, or moistening roller.

11. A computer program with program code means, for performing all the steps of a method as defined by claim 1, if the computer program is executed on a computer or a corresponding computation unit, in particular in a printing press (1).

12. A computer program product with program code means, which are stored in memory on a computer-readable data medium, for performing all the steps of a method as defined by claim 1, if the computer program is executed on a computer or a corresponding computation unit, in particular in a printing press (1).
